(19) United States
(12) Patent Application Publication
(10) Pub. No.: US 2022/0207446 A1
(43) Pub. Date: Jun. 30, 2022

(54) METHOD AND SYSTEM FOR IMPROVING TRIP ORDER DISPATCHING

(71) Applicant: Beijing DiDi Infinity Technology and Development Co., Ltd., Beijing (CN)

(72) Inventors: Conghui FU, SANTA CLARA, CA (US); Wei WANG, SUNNYVALE, CA (US); Zihan YI, MOUNTAIN VIEW, CA (US); Fangfei GE, MOUNTAIN VIEW, CA (US); Xin CHEN, SUNNYVALE, CA (US)

(21) Appl. No.: 17/139,120

(22) Filed: Dec. 31, 2020

(51) Int. Cl. G06Q 10/06; G06N 20/00

(52) U.S. Cl. CPC G06Q 10/06311; G06N 20/00

(57) ABSTRACT

Systems, methods, and non-transitory computer-readable media can receive a first trip order and a trip whitelist. The first trip order comprises a first passenger and first points of interest (POIs). In response to either the first POIs or the first passenger being in the trip whitelist, dispatching a driver to the first trip order. In response to neither the first POIs nor the first passenger being in the trip whitelist, a determination is made whether to add the first POIs or the first passenger to the trip whitelist. In response to a determination not to add the first POIs or the first passenger to the trip whitelist, a trip risk score is determined for the first trip order based on a trip-risk evaluation machine learning model, and a driver is dispatched to the first trip order based on the trip risk score.

### TECHNICAL FIELD

The disclosure generally relates to system and methods for ridesharing, particularly, improving trip order dispatching using whitelists.

### BACKGROUND

Under traditional approaches, ridesharing platforms may connect passengers and drivers on relatively short notice. However, traditional ridesharing platforms suffer from a variety of safety and security risks for both passengers and drivers.

### SUMMARY

In one aspect of the present disclosure, in various implementations, a method may include receiving, by a computing system, a first trip order and a trip whitelist. The first trip order comprises a first passenger and first points of interest (POIs). The trip whitelist comprises a plurality of passengers and a plurality of POIs. The method may also include, in response to either the first POIs or the first passenger being in the trip whitelist, dispatching, by the computing system, a driver to the first trip order. The method may further include, in response to neither the first POIs nor the first passenger being in the trip whitelist, determining, by the computing system, whether to add the first POIs or the first passenger to the trip whitelist based at least on a set of whitelist-determination rules or a whitelist-determination machine learning model. In response to a determination not to add the first POIs or the first passenger to the trip whitelist, determining, by the computing system, a trip risk score for the first trip order based on a trip-risk evaluation machine learning model, and dispatching, by the computing system, a driver to the first trip order based on the trip risk score.

In another aspect of the present disclosure, a computing system may comprise at least one processor and a memory storing instructions that, when executed by the at least one processor, cause the computing system to perform operations. The operations may include receiving a first trip order and a trip whitelist. The first trip order comprises a first passenger and first points of interest (POIs). The trip whitelist comprises a plurality of passengers and a plurality of POIs. The operations may also include, in response to either the first POIs or the first passenger being in the trip whitelist, dispatching a driver to the first trip order. The operations may further include, in response to neither the first POIs nor the first passenger being in the trip whitelist, determining whether to add the first POIs or the first passenger to the trip whitelist based at least on a set of whitelist-determination rules or a whitelist-determination machine learning model. In response to a determination not to add the first POIs or the first passenger to the trip whitelist, determining a trip risk score for the first trip order based on a trip-risk evaluation machine learning model, and dispatching a driver to the first trip order based on the trip risk score.

Yet another aspect of the present disclosure is directed to a non-transitory computer-readable storage medium including instructions that, when executed by at least one processor of a computing system, cause the computing system to perform operations. The operations may include receiving a first trip order and a trip whitelist. The first trip order comprises a first passenger and first points of interest (POIs). The trip whitelist comprises a plurality of passengers and a plurality of POIs. The operations may also include, in response to either the first POIs or the first passenger being in the trip whitelist, dispatching a driver to the first trip order. The operations may further include, in response to neither the first POIs nor the first passenger being in the trip whitelist, determining whether to add the first POIs or the first passenger to the trip whitelist based at least on a set of whitelist-determination rules or a whitelist-determination machine learning model. In response to a determination not to add the first POIs or the first passenger to the trip whitelist, determining a trip risk score for the first trip order based on a trip-risk evaluation machine learning model, and dispatching a driver to the first trip order based on the trip risk score.

In some embodiments, the first POIs comprise a pickup location and a drop off location.

In some embodiments, the set of whitelist-determination rules comprises a set of POI-whitelist-determination rules and a set of passenger-whitelist-determination rules.

In some embodiments, the determining whether to add the first POIs or the first passenger to the trip whitelist based on a set of whitelist-determination rules further comprises: determining, by the computing system, whether to add the first POIs to the trip whitelist based on the set of POI-whitelist-determination rules; in response to a determination to add the first points of interest to the trip whitelist, updating, by the computing system, the trip whitelist by adding the first points of interest to the trip whitelist; determining, by the computing system, whether to add the first passenger to the trip whitelist based on the set of passenger-whitelist-determination rules; and in response to a determination to add the first passenger to the trip whitelist, updating, by the computing system, the trip whitelist by adding the first passenger to the trip whitelist.

In some embodiments, the set of POI whitelist rules are based on POI data during a time period. The POI data include a number of trip orders associated with the POI that were placed during the time period and a number of incidents associated with the POI occurred during the time period.

In some embodiments, the set of passenger whitelist rules are based on passenger behavior data during a time period. The passenger behavior data include: a corresponding number of trip orders of the passenger placed at distinct hours each day during the time period, and a number of times when one or more trip orders of the passenger have a same pickup location or a same drop off location during the time period.

In some embodiments, the determining whether to add the first POIs or the first passenger to the trip whitelist is based on a whitelist-determination machine learning model. The determining further comprises: determining, by the computing system, a whitelist score for the first trip order using the whitelist-determination machine learning model based on POI data and passenger behavior data collected for a time period; and determining, by the computing system, whether to add the first POIs or the first passenger to the trip whitelist based on the whitelist score.

In some embodiments, the whitelist-determination machine learning model is trained based on a training dataset comprising a plurality of historical trips spanning over a predetermined duration of time.

In some embodiments, the passenger-whitelist-determination machine learning model is a neural network model.

In some embodiments, the trip-evaluation machine learning model is a tree-based ensemble model.

These and other features of the methods, systems, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for a ridesharing platform system, in accordance with various embodiments of the disclosure.

FIG. 2 illustrates an example environment of a ridesharing platform system, in accordance with various embodiments of the disclosure.

FIG. 3 illustrates an example system diagrams for identification of misclassifications of passengers and locations in trip orders, in accordance with various embodiments of the disclosure.

FIGS. 4A-4B illustrate example graphs of passenger behavior data, in accordance with various embodiments of the disclosure.

FIG. 5 illustrates a flowchart of an example method for identification of misclassifications of passengers and locations in trip orders, in accordance with various embodiments of the disclosure.

FIG. 6 illustrates a block diagram of an example computing system in which the embodiments described herein may be implemented.

### DETAILED DESCRIPTION

Specific, non-limiting embodiments of the present invention will now be described with reference to the drawings. It is to be understood that features and aspects of any embodiment disclosed herein may be used and/or combined with features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed within the spirit, scope and contemplation of the present invention as further defined in the appended claims.

The approaches disclosed herein enable and/or improve the safety and security of a ridesharing service. For example, sexual harassment and abuse incidents may have a high occurrence rate in certain geographical regions. As used herein, the incidents may be physical incidents (e.g., physical assaults, sexual harassment, and sexual abuses). A strong correlation exists between incidents with passengers being offenders and the drivers being victims and the passengers' behavior patterns on a ridesharing platform. It is important for a ridesharing platform to efficiently detect and block aggressive passengers. However, it is not desirable to misjudge normal passengers and thereby reduce user experience of normal passengers.

In various embodiments, the computer system can receive a trip order and a trip whitelist. The trip order comprises a passenger and points of interest (POIs) including a pickup location and a drop off location. The trip whitelist is a list of passengers and points of interest that are considered safe and allowed to bypass a trip risk evaluation process. If neither the points of interest nor the passenger is in the trip whitelist, a determination is made whether to update the trip whitelist by adding the points of interest or the first passenger to the trip whitelist. In response to a determination not to update the trip whitelist, a trip risk score is determined based on a trip-risk evaluation machine learning model. If the trip risk score is above a threshold, a driver is dispatched to the trip order. If either the POIs or the first passenger is in the trip whitelist, the trip order is considered safe. Thus, without going through a trip evaluation process, i.e. a trip risk score determination using a trip-risk evaluation machine learning model, the passenger is provided ridesharing service from the driver. Thus, for normal passengers who represent majority of all passengers, the waiting time to receive the ridesharing service is reduced, and their user experience is enhanced.

In various embodiments, the determination whether to update the trip whitelist by adding the points of interest or the first passenger to the trip whitelist can be based on a set of whitelist-determination rules or a whitelist-determination machine learning model. The set of whitelist-determination rules can include a set of POI-whitelist-determination rules and a set of passenger-whitelist-determination rules. The whitelist-determination machine learning model can be any type of machine learning model, e.g., a neural network model. The whitelist-determination machine learning model can be trained based on historical trips spanning over a predetermined duration of time. More details relating to the disclosed technology are provided below.

### Passenger, Driver, and Ridesharing Platform System

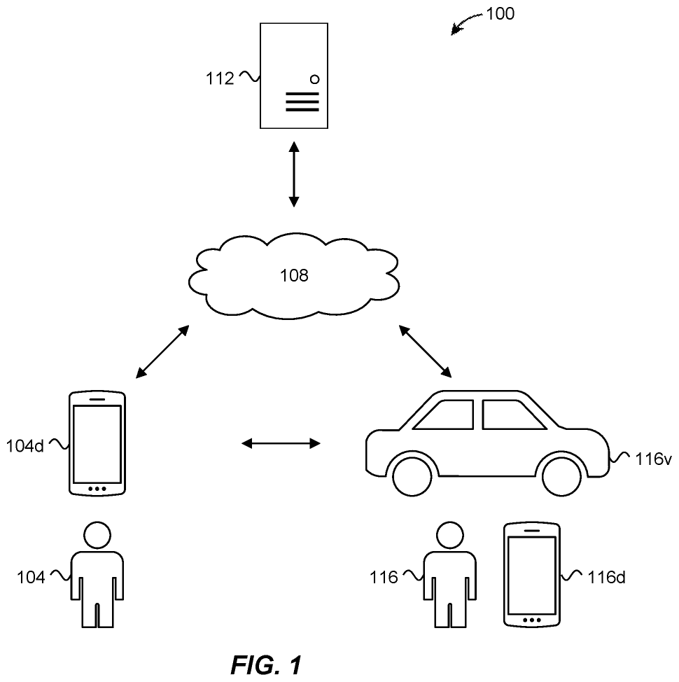

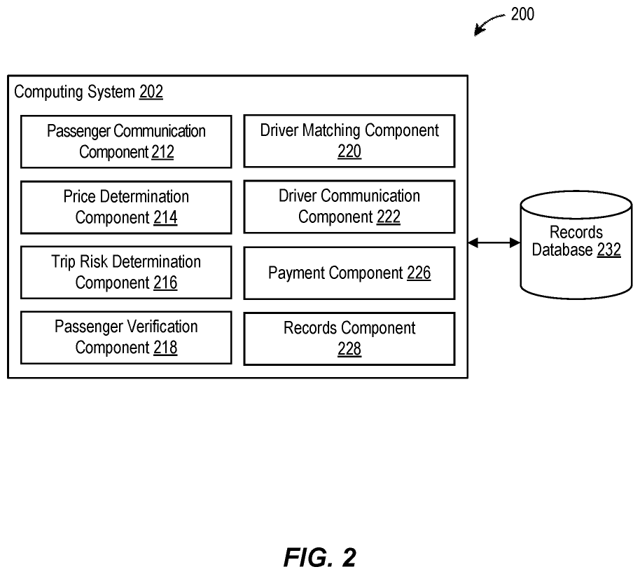

FIG. 1 illustrates an example environment for a ridesharing platform system. In the environment 100 illustrates in FIG. 1, a passenger 104 uses a passenger device 104d (e.g., a smartphone, a tablet, or a computer) to make a trip request, via a communication network 108 (e.g., the Internet) to a ridesharing platform system 112 (such as the computing system 200 described with reference to FIG. 2). The ridesharing platform system 112 can assign a driver 116 and the driver's vehicle 116v (e.g., a car, an SUV, and a truck) to fulfill the trip request. The driver 116 can receive and accept or decline the trip request using a driver device 116d (e.g., a smartphone, a tablet, or a computer). The driver device 116d can be a standalone device or part of the driver's vehicle 116v.

During an onboarding process, the passenger 104 and the driver 116 can provide personal information to the ridesharing platform system 112. Stringent background checks can increase driver safety and passenger safety. The passenger 104 can provide the ridesharing platform system 112 with a pickup or starting location and a drop off or destination location of a trip and receive pricing information (e.g., the estimated cost of the trip) and time information (e.g. the estimated duration of the trip). If the pricing information and time information are acceptable to the passenger 104, the passenger 104 can make a trip request or place an order (e.g., by clicking an order button) to the ridesharing platform system 112. After receiving the trip request from the passenger 104, the ridesharing platform system 112 can decide whether to accept the trip request and assign or match the driver 116 to the passenger for the trip request. Declining or rejecting a trip request of a passenger determined to be likely an offender in an incident can increase driver safety. The driver 116 can proceed to and arrive at the pickup location, where the passenger 104 can enter the driver's vehicle 116v and be transported, by the driver 116 using the vehicle 116v, to the drop off location of the trip request or order. The passenger 104 can pay (e.g., with cash or via the ridesharing platform system 112) the driver 116 after arrival at the drop off location.

Using the passenger device 104d, the passenger 104 can interact with the ridesharing platform system 112 and request ridesharing services. For example, the passenger 140, using the passenger device 104d, can make a trip request to the ridesharing platform system 112. A trip request can include rider identification information, the number of passengers for the trip, a requested type of the provider (e.g., a vehicle type or service option identifier), the pickup location (e.g., a user-specified location, or a current location of the passenger device 104d as determined using, for example, a global positioning system (GPS) receiver), and/or the destination for the trip.

The passenger device 104d can interact with the ridesharing platform system 112 through a client application configured to interact with the ridesharing platform system 112. The client application can present information, using a user interface, received from the ridesharing platform system 112 and transmit information to the ridesharing platform system 112. The information presented on the user interface can include driver-related information, such as driver identity, driver vehicle information, driver vehicle location, and driver estimated arrival. The information presented on the user interface can include the drop off location, a route from the pickup location to the drop off location, an estimated trip duration, an estimated trip cost, and current traffic condition. The passenger device 104d can include a location sensor, such as a global positioning system (GPS) receiver, that can determine the current location of the passenger device 104d. The user interface presented by the client application can include the current location of the passenger device 104. The information transmitted can include a trip request, a pickup location, and a drop off location.

The ridesharing platform system 112 can allow the passenger 104 to specify parameters for the trip specified in the trip request, such as a vehicle type, a pick-up location, a trip destination, a target trip price, and/or a departure timeframe for the trip. The ridesharing platform system 112 can determine whether to accept or reject the trip request and, if so, assign or attempt to assign the driver 116 with the driver vehicle 116v and the driver device 116d to the passenger 104 and the passenger's trip request. For example, the ridesharing platform system 112 can receive a trip request from the passenger device 104d, select a driver from a pool of available drivers to provide the trip, and transmit an assignment request to the selected driver's device 116d.

The driver 116 can interact with, via the driver device 116d, the ridesharing platform system 112 to receive an assignment request to fulfill the trip request. The driver can decide to start receiving assignment requests by going online (e.g., launching a driver application and/or providing input on the driver application to indicate that the driver is receiving assignments), and stop receiving assignment requests by going offline. The driver 116 can receive, from the ridesharing platform system 112, an assignment request to fulfill a trip request made by the passenger using the passenger device 104d to the ridesharing platform system 112. The driver 116 can, using the driver device 116d, accept or reject the assignment request. By accepting the assignment request, the driver 116 and the driver's vehicle 116v are assigned to the particular trip of the passenger 104 and are provided the passenger's pickup location and trip destination.

The driver device 116d can interact with the ridesharing platform system 112 through a client application configured to interact with the ridesharing platform system 112. The client application can present information, using a user interface, received from the ridesharing platform system 112 (e.g., an assignment request, a pickup location, a drop off location, a route from the pickup location to the drop off location, an estimated trip duration, current traffic condition, and passenger-related information, such as passenger name and gender) and transmit information to the ridesharing platform system 112 (e.g., an acceptance of an assignment request). The driver device 116d can include a location sensor, such as a global positioning system (GPS) receiver, that can determine the current location of the driver device 116d. The user interface presented by the client application can include the current location of the driver device 116 and a route from the current location of the driver device 116 to the pickup location. After accepting the assignment, the driver 116, using the driver's vehicle 116v, can proceed to the pickup location of the trip request to pick up the passenger 104.

The passenger device 104d and the driver device 116d can communicate with the ridesharing platform system 112 via the network 108 can include one or more local area and wide area networks employing wired and/or wireless communication technologies (e.g., 3G, 4G, and 5G), one or more communication protocols (e.g., transmission control protocol/Internet protocol (TCP/IP) and hypertext transport protocol (HTTP)), and one or more formats (e.g., hypertext markup language (HTML) and extensible markup language (XML).

### Trip Risk Evaluation

FIG. 2 illustrates an example environment 200 for a ridesharing platform system, in accordance with various embodiments. The example environment 200 may include a ridesharing computing system 202. The computing system 202 may include one or more processors and memory (e.g., permanent memory, temporary memory). The processor(s) may be configured to perform various operations by interpreting machine-readable instructions stored in the memory. The computing system 202 may include other computing resources. The computing system 202 may have access (e.g., via one or more connections, via one or more networks) to other computing resources.

The computing system 202 may include a passenger communication component 212, a price determination component 214, a trip risk determination component 216, a passenger verification component 218, a driver matching component 220, a driver communication component 224, a payment component 226, and a trip records component 228. The computing system 202 may include other components. While the computing system 202 is shown in FIG. 2 as a single entity, this is merely for ease of reference and is not meant to be limiting. One or more components or one or more functionalities of the computing system 202 described herein may be implemented in software. One or more components or one or more functionalities of the computing system 202 described herein may be implemented in hardware. One or more components or one or more functionalities of the computing system 202 described herein may be implemented in a single computing device or multiple computing devices. In some embodiments, one or more components or one or more functionalities of the computing system 202 described herein may be implemented in one or more networks (e.g., enterprise networks), one or more endpoints, one or more servers, or one or more clouds.

A passenger, such as the passenger 104 described with reference to FIG. 1 (or a passenger's device, such as the passenger device 104 described with reference to FIG. 1) can communicate with the ridesharing computing system 202 via the passenger communication component 212. For example, during the trip request process, the passenger can provide personal information to the ridesharing computing system 202 via the passenger communication component 212. For example, the passenger can provide the ridesharing computing system 202, via the passenger communication component 212, with a pickup location and a drop off location of a trip. For example, the passenger communication component 212 can provide the passenger with pricing information of the trip (e.g., the estimated cost of the trip) and time information of the trip (e.g. the estimated duration of the trip). If the pricing information and time information are acceptable to the passenger, the passenger can make a trip request or place an order (e.g., by clicking an order button) to the ridesharing computing system 202, via the passenger communication component 212. After receiving the trip request from the passenger, the ridesharing computing system 202 can determine whether to accept or decline the trip request or order based on a risk of the trip determined by the risk determination component 216. The risk determination component 216 can determine the risk of the trip using the verification information provided by the passenger and the validity of the verification information determined by the passenger verification component 218. If the risk is acceptable (e.g., below a threshold level), the ridesharing computing system 202 can assign or match the driver to the passenger for the particular trip request using the driver matching component 220. The ridesharing computing system 202, using the driver communication component 224, can provide the assigned driver with an assignment of the trip request. The ridesharing computing system 202, using the driver communication component 224, can receive the driver's acceptance of the assignment of the trip request. The driver communication component 224 can provide the driver with information relating to the progress of the trip, such as the driver's distances from the pickup location and drop off location and a route from the pickup location to the drop off location. The ridesharing computing system 202, using the payment component 226, can receive the passenger's payment for the trip. The records component 228 can store information related to the trip (e.g., the driver information) in the records database 232. The records database 232 can also store the passenger information and the driver information (e.g., received during the registration process, such as the passenger's name, or trip request process).

In determining the risk of a trip, the trip risk determination component 216 may acquire, analyze, determine, examine, identify, load, locate, obtain, open, receive, retrieve, and/or review driver and passenger information. The trip risk determination component 216 may access the driver and passenger information from one or more locations. For example, the risk determination component 216 may access driver and passenger information from a storage location, such as an electronic storage 232 of the computing system 202, an electronic storage of a device accessible via a network, another computing device/system (e.g., desktop, laptop, smartphone, tablet, mobile device), or other locations.

A passenger who plans an incident with respect to a driver may have shown certain behavior patterns. For example, a passenger may cancel several trip requests until the driver finds a target driver. After a passenger makes a request for a trip, whether the trip is risky can be determined by the trip risk determination component 216. The ridesharing system can recognize passengers having negative behaviors and deny their access to the ridesharing service. However, it is undesirable to misjudges normal passengers and locations. A trip whitelist can be employed to expedite a trip dispatching process and to reduce the risk of misclassifying normal passengers.

### System for Improving Trip Order Dispatching Using Whitelists

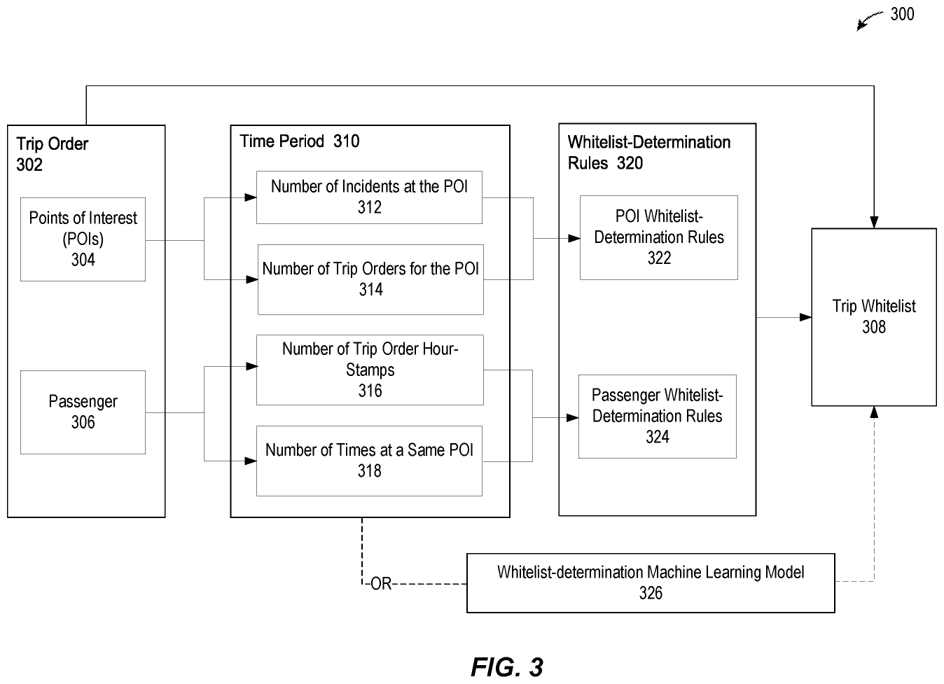

FIG. 3 illustrates an example system diagram for identification of misclassifications of passengers and locations, in accordance with various embodiments of the disclosure.

In some embodiments, a trip order 302 comprises points of interest (POIs) 304 and a passenger 306. The POIs 304 include a pickup location and a drop off location. Different POIs 304 may be associated with different risk levels. For example, based on historical data and/or public data, a location (i.e., the pickup location or the drop off location) at or near a nightclub or a bar during a specific time window may be determined as unsafe. The passenger 306 may include normal passengers and suspicious passengers who are susceptible to commit crimes.

In some embodiments, a trip whitelist 308 is a list of passengers and points of interest that are considered safe and allowed to bypass a trip risk evaluation. A time period 310 is a period of time during which a passenger's behavior data and POI data are collected for analysis. A number of incidents at the POI 312 is a total number of historical incidents occurred at the POI during the time period. A number of trip orders for the POI 314 is a total number of trip orders for the POI placed during the time period.

A number of trip order hour-stamps 316 is the number of trip orders placed by a passenger at distinct hours in one day. For example, if a passenger places orders at 13:09, 13:15, and 14:20 in one day, then the number of trip order hour stamps is 2, because the two orders placed at 13:09 and 13:15 has the same hour-stamp 13 and the order placed at 14:20 has an hour-stamp 14. A number of times at a same POI 318 is a number of times when a passenger starts or arrives at the same POI.

In some embodiments, whitelist-determination rules 320 can include POI whitelist-determination rules 322 and passenger whitelist-determination rules 324. The POI whitelist-determination rules 322 is a set of rules to determine whether the points of interest 304 associated with the trip order 302 are safe and should be added to the trip whitelist 308. The passenger whitelist-determination rules 324 is a set of rules to determine whether the passenger 306 associated with the trip order 302 is a normal passenger and should be added to the trip whitelist 308.

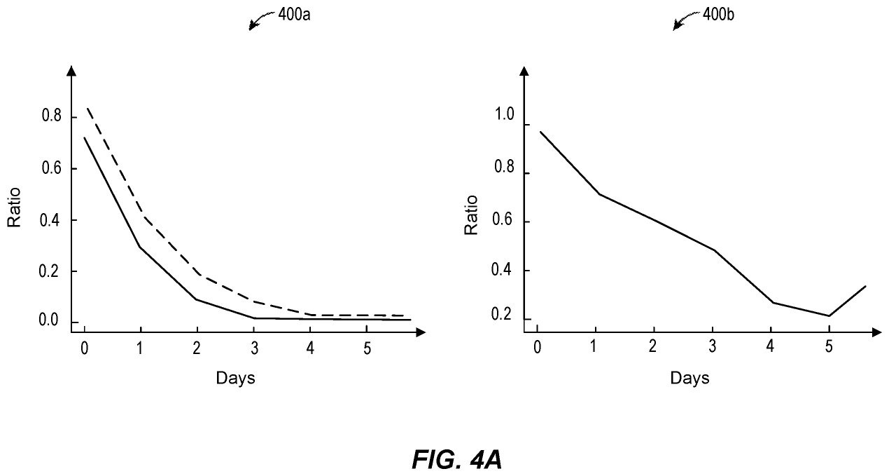

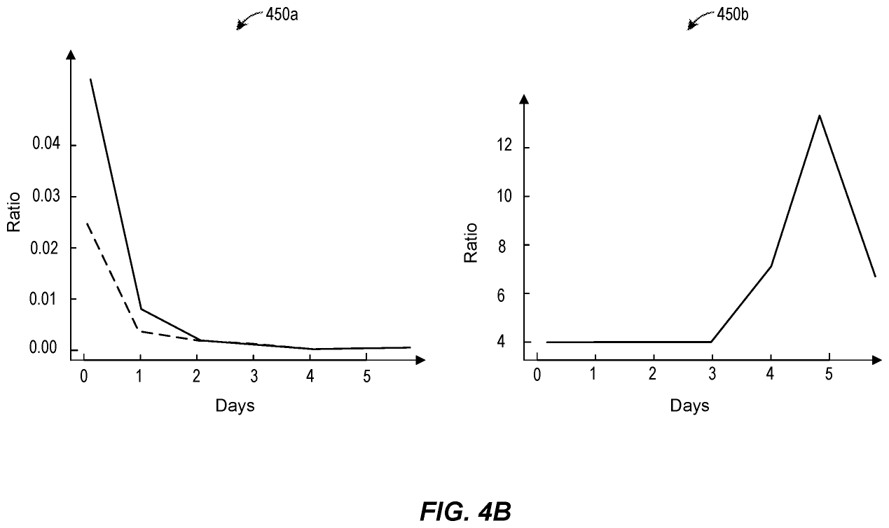

FIGS. 4A-4B illustrate example graphs of empirical passenger behavior data, in accordance with various embodiments of the disclosure.

In FIG. 4A, graph 400a depicts a comparison of numbers of trip order hour-stamps of aggressor passengers and normal passengers. The x-axis depicts the number of days a passenger places orders at no more than two hour-stamps. The y-axis denotes a percentage of passengers having such behavior. The dashed curve depicts the behavior pattern for normal passengers, and the solid curve depicts the behavior pattern for aggressor passengers. Graph 400b depicts a ratio between a number of aggressor passengers and a number of normal passengers having such behavior.

According to the graphs 400a and 400b, normal passengers usually place orders at no more than two hour-stamps. Especially, when a passenger has less than two trip order hour-stamps in a day and continues this behavior pattern for several days, a determination can be made that the passenger is a normal passenger.

In FIG. 4B, graph 450a depicts a comparison of numbers of times when the aggressor passengers and normal passengers start or arrive at a same location. The x-axis depicts the number of days a passenger starts or arrives at a same location. The y-axis denotes a percentage of passengers having such behavior. The dashed curve depicts the behavior pattern for normal passengers, and the solid curve depicts the behavior pattern for aggressor passengers. Graph 450b depicts a ratio between a number of aggressor passengers and a number of normal passengers having such behavior.

According to the graphs 450a and 450b, passengers who start or arrive at the same locations for many days are a strong signal that the passengers are normal. When the passengers start or arrive at the same location more than three times, the probability for them to conduct crimes is four times lower.

Based on the empirical data depicted in FIGS. 4A-4B, a set of POI whitelist-determination rules 322 and a set of passenger whitelist-determination rules 324 can de defined. For example, if a POI has stable high-volume orders per week with few incidents, the POI can be deemed safe and added to a trip whitelist. If a passenger places orders at no more than two different hours in a day, or the passenger starts or arrives at a same location for many days, the passenger can be deemed normal and added to the trip whitelist. Many variations are possible.

### Method for Improving Trip Order Dispatching Using Whitelists

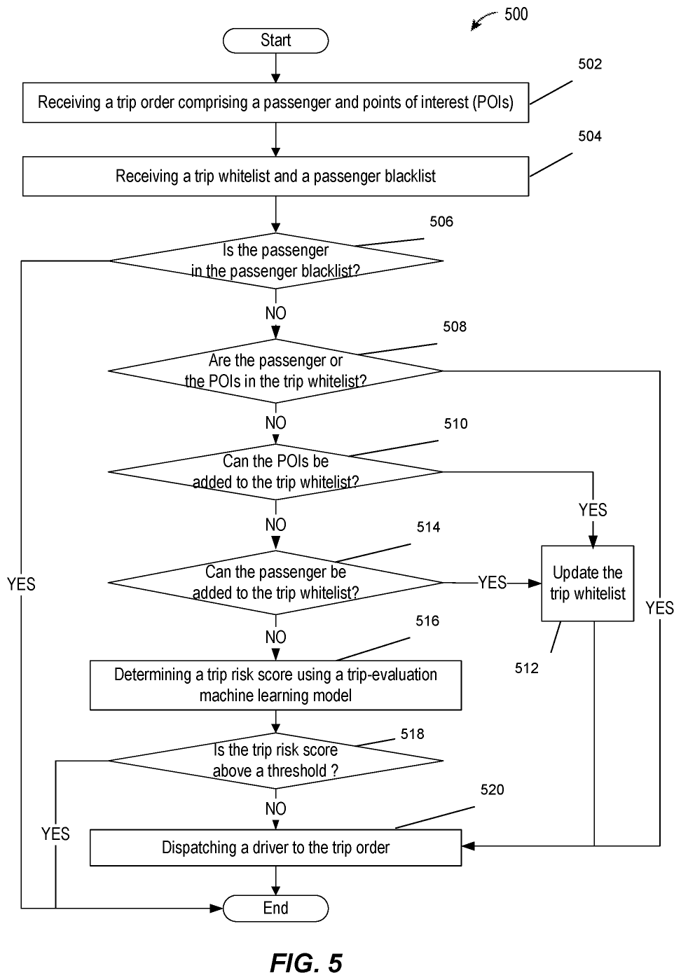

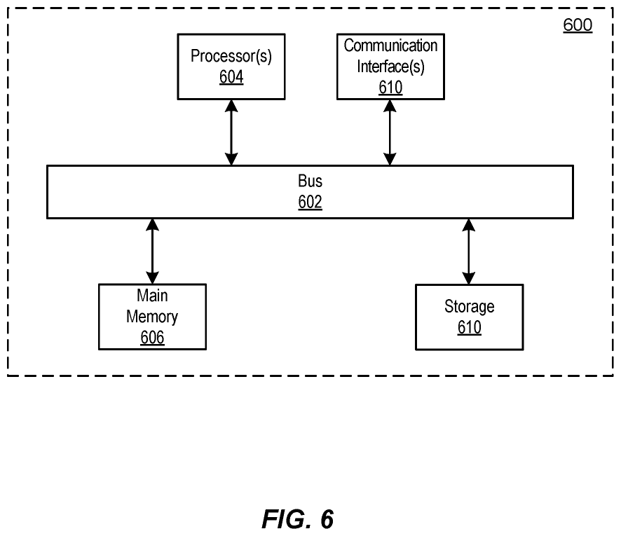

FIG. 5 illustrates a flowchart of an example method 500 for identification of safe passengers and locations, according to various embodiments of the present disclosure. The method 500 can be implemented in various environments including, for example, the environment 200 of FIG. 2 and by computer systems, such as the computer system 202 of FIG. 2, or the computer system 600 of FIG. 6. The operations of the method 500 presented below are intended to be illustrative. Depending on the implementation, the method 500 can include additional, fewer, or alternative steps performed in various orders or in parallel. The method 500 can be implemented in various computing systems or devices including one or more processors.

With respect to the method 500, at block 502, a computing system (such as the computer system 202 of FIG. 2, or the computer system 600 of FIG. 6) can receive a trip order comprising a passenger and points of interest (POIs). The points of interest include a pickup location and a drop off location. At block 504, The computing system can also receive a trip whitelist and a passenger blacklist.

With respect to the method 500, at block 506, the computing system can determine whether the passenger is in the passenger blacklist. The passenger blacklist is a list of passengers who have record of negative behaviors. If a passenger is in the passenger blacklist, the passenger is denied access to the ridesharing service, and the trip order is rejected.

If the passenger is not in the passenger blacklist, at block 508, the computing system can determine if either the passenger or the POIs is in the trip whitelist. If either the passenger or the POIs are in the trip whitelist, at block 520, a driver is dispatched to the trip order without going through a trip risk evaluation process.

If neither the passenger nor the POIs are in the trip whitelist, at block 510, the computing system can determine whether the POIs are qualified to be added to the trip whitelist. The determination can be based on the POI whitelist-determination rules 320 or a whitelist-determination machine learning model 326. The whitelist-determination machine learning model 326 can be any type of machine learning models, e.g., a neural network model.

If the POIs are qualified to be added to the trip whitelist, at block 512, the computing system can update the trip whitelist 308 by adding the POIs to the trip whitelist 308. At block 514, the computing system can determine whether the passenger is qualified to be added to the trip whitelist based on the passenger whitelist-determination rules 324. In some embodiments, the determination in block 510 and the determination in block 514 are independent from each other. In other embodiments, the determinations in block 510 and block 514 may be performed in any order or in parallel.

If the passenger is qualified to be added to the trip whitelist, at block 512, the computing system can update the trip whitelist 308 by adding the passenger to the trip whitelist 308. If the passenger is not qualified to be added to the trip whitelist, at block 516, the computing system can determine a risk score for the trip order using a trip-evaluation machine learning model based on passenger data and POI data.

The trip-evaluation machine learning model can be any type of machine learning models. In some embodiments, the risk-evaluation machine learning model 346 is a tree-based ensemble model such as Random Forest, Extremely Randomized Trees, Adaptive Boosting, Gradient Boosting, etc.

At block 518, the computing system can determine whether the risk score is above a predefined threshold. If the risk score is above the predefined threshold, the trip order is deemed too risky, and the trip order is rejected. If the risk score is not above the predefined threshold, at block 520, a driver is dispatched to the trip order after going through a trip risk evaluation process.

### Computer System

FIG. 6 is a block diagram that illustrates a computer system 600 upon which any of the embodiments described herein may be implemented. The computer system 600 includes a bus 602 or other communication mechanisms for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache and/or other dynamic storage devices, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, render computer system 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 608. Execution of the sequences of instructions contained in main memory 606 causes processor(s) 604 to perform the process steps described herein. For example, the process/method shown in FIG. 5 and described in connection with this figure may be implemented by computer program instructions stored in main memory 606. When these instructions are executed by processor(s) 604, they may perform the steps as shown in FIG. 5 and described above. In alternative embodiments, hard-wired circuitry may be used in place of or in combination with software instructions.

The computer system 600 also includes a communication interface 610 coupled to bus 602. Communication interface 610 provides a two-way data communication coupling to one or more network links that are connected to one or more networks. As another example, communication interface 610 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 202 may be described as performing or configured for performing an operation, when the components may comprise instructions which may program or configure the computing system 202 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are equivalent in meaning and be open ended in that an item or items following any of these words is not meant to be an exhaustive listing of such item or items, or meant to be limited to only the listed item or items. It must also be noted that as used herein and in the appended claims, the singular forms “a,” “an,” and “the” include plural references unless the context dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method, comprising:
receiving, by a computing system, a first trip order and a trip whitelist,
wherein the first trip order comprises a first passenger and first points of interest (POIs), and
wherein the trip whitelist comprises a plurality of passengers and a plurality of POIs;
in response to either the first POIs or the first passenger being in the trip whitelist, dispatching, by the computing system, a driver to the first trip order; and
in response to neither the first POIs nor the first passenger being in the trip whitelist,
determining, by the computing system, whether to add the first POIs or the first passenger to the trip whitelist based at least on a set of whitelist-determination rules or a whitelist-determination machine learning model, and
in response to a determination not to add the first POIs or the first passenger to the trip whitelist,
determining, by the computing system, a trip risk score for the first trip order based on a trip-risk evaluation machine learning model, and
dispatching, by the computing system, a driver to the first trip order based on the trip risk score.

2. The computer-implemented method of claim 1, wherein the first POIs comprise a pickup location and a drop off location.

3. The computer-implemented method of claim 1, wherein the set of whitelist-determination rules comprises a set of POI-whitelist-determination rules and a set of passenger-whitelist-determination rules.

4. The computer-implemented method of claim 3, wherein the determining whether to add the first POIs or the first passenger to the trip whitelist based on the set of whitelist-determination rules further comprises:
determining, by the computing system, whether to add the first POIs to the trip whitelist based on the set of POI-whitelist-determination rules;
in response to a determination to add the first points of interest to the trip whitelist,
updating, by the computing system, the trip whitelist by adding the first points of interest to the trip whitelist;
determining, by the computing system, whether to add the first passenger to the trip whitelist based on the set of passenger-whitelist-determination rules; and
in response to a determination to add the first passenger to the trip whitelist,
updating, by the computing system, the trip whitelist by adding the first passenger to the trip whitelist.

5. The computer-implemented method of claim 3, wherein the set of POI-whitelist-determination rules are based on POI data during a time period, wherein the POI data include a number of trip orders associated with a POI that were placed during the time period and a number of incidents associated with the POI occurred during the time period.

6. The computer-implemented method of claim 3, wherein the set of passenger-whitelist-determination rules are based on passenger behavior data during a time period, wherein the passenger behavior data include: a corresponding number of trip orders of the passenger placed at distinct hours each day during the time period, and a number of times when one or more trip orders of the passenger have a same pickup location or a same drop off location during the time period.

7. The computer-implemented method of claim 1, wherein the determining whether to add the first POIs or the first passenger to the trip whitelist based on the whitelist-determination machine learning model further comprises:
determining, by the computing system, a whitelist score for the first trip order using the whitelist-determination machine learning model based on POI data and passenger behavior data collected for a time period; and
determining, by the computing system, whether to add the first POIs or the first passenger to the trip whitelist based on the whitelist score.

8. The computer-implemented method of claim 1, wherein the whitelist-determination machine learning model is trained based on a training dataset comprising a plurality of historical trips spanning over a predetermined duration of time.

9. The computer-implemented method of claim 1, wherein the passenger-whitelist-determination machine learning model is a neural network model.

10. The computer-implemented method of claim 1, wherein the trip-evaluation machine learning model is a tree-based ensemble model.

11. A system comprising:
at least one processor; and
a memory storing instructions that, when executed by the at least one processor, cause the system to perform operations comprising:
receiving a first trip order and a trip whitelist,
wherein the first trip order comprises a first passenger and first points of interest (POIs), and
wherein the trip whitelist comprises a plurality of passengers and a plurality of POIs;
in response to either the first POIs or the first passenger being in the trip whitelist,
dispatching a driver to the first trip order; and
in response to neither the first POIs nor the first passenger being in the trip whitelist,
determining whether to add the first POIs or the first passenger to the trip whitelist based at least on a set of whitelist-determination rules or a whitelist-determination machine learning model, and
in response to a determination not to add the first POIs or the first passenger to the trip whitelist,
determining a trip risk score for the first trip order based on a trip-risk evaluation machine learning model, and
dispatching a driver to the first trip order based on the trip risk score.

12. The system of claim 11, wherein the set of whitelist-determination rules comprises a set of POI-whitelist-determination rules and a set of passenger-whitelist-determination rules.

13. The system of claim 12, wherein the determining whether to add the first POIs or the first passenger to the trip whitelist based on the set of whitelist-determination rules further comprises:
determining whether to add the first POIs to the trip whitelist based on the set of POI-whitelist-determination rules;
in response to a determination to add the first points of interest to the trip whitelist,
updating the trip whitelist by adding the first points of interest to the trip whitelist;
determining whether to add the first passenger to the trip whitelist based on the set of passenger-whitelist-determination rules; and
in response to a determination to add the first passenger to the trip whitelist,
updating the trip whitelist by adding the first passenger to the trip whitelist.

14. The system of claim 11, wherein the determining whether to add the first POIs or the first passenger to the trip whitelist based on the whitelist-determination machine learning model further comprises:
determining a whitelist score for the first trip order using the whitelist-determination machine learning model based on POI data and passenger behavior data collected for a time period; and
determining whether to add the first POIs or the first passenger to the trip whitelist based on the whitelist score.

15. The system of claim 11, wherein the whitelist-determination machine learning model is trained based on a training dataset comprising a plurality of historical trips spanning over a predetermined duration of time.

16. A non-transitory computer-readable storage medium including instructions that, when executed by at least one processor of a computing system, cause the computing system to perform operations comprising:
receiving a first trip order and a trip whitelist,
wherein the first trip order comprises a first passenger and first points of interest (POIs), and
wherein the trip whitelist comprises a plurality of passengers and a plurality of POIs;
in response to either the first POIs or the first passenger being in the trip whitelist, dispatching a driver to the first trip order; and
in response to neither the first POIs nor the first passenger being in the trip whitelist,
determining whether to add the first POIs or the first passenger to the trip whitelist based at least on a set of whitelist-determination rules or a whitelist-determination machine learning model, and
in response to a determination not to add the first POIs or the first passenger to the trip whitelist,
determining a trip risk score for the first trip order based on a trip-risk evaluation machine learning model, and
dispatching a driver to the first trip order based on the trip risk score.

17. The non-transitory computer-readable storage medium of claim 16, wherein the set of whitelist-determination rules comprises a set of POI-whitelist-determination rules and a set of passenger-whitelist-determination rules.

18. The non-transitory computer-readable storage medium of claim 17, wherein the determining whether to add the first POIs or the first passenger to the trip whitelist based on the set of whitelist-determination rules further comprises:
determining whether to add the first POIs to the trip whitelist based on the set of POI-whitelist-determination rules;
in response to a determination to add the first points of interest to the trip whitelist,
updating the trip whitelist by adding the first points of interest to the trip whitelist;
determining whether to add the first passenger to the trip whitelist based on the set of passenger-whitelist-determination rules; and
in response to a determination to add the first passenger to the trip whitelist,
updating the trip whitelist by adding the first passenger to the trip whitelist.

19. The non-transitory computer-readable storage medium of claim 16, wherein the determining whether to add the first POIs or the first passenger to the trip whitelist based on the whitelist-determination machine learning model further comprises:
determining a whitelist score for the first trip order using the whitelist-determination machine learning model based on POI data and passenger behavior data collected for a time period; and
determining whether to add the first POIs or the first passenger to the trip whitelist based on the whitelist score.

20. The non-transitory computer-readable storage medium of claim 16, wherein the whitelist-determination machine learning model is trained based on a training dataset comprising a plurality of historical trips spanning over a predetermined duration of time.
